(19) United States
(12) Patent Application Publication
(10) Pub. No.: US 2010/0133341 A1
(43) Pub. Date: Jun. 3, 2010

(54) METHOD FOR IDENTIFYING A MACHINE-READABLE CODE APPLIED TO A POSTAL ITEM, DEVICE FOR CARRYING OUT SAID METHOD, POSTAL ITEM AND METHOD FOR PROVIDING THE POSTAL ITEM WITH THE MACHINE-READABLE CODE

(75) Inventors: Bernd Meyer, Konigswinter (DE); Jürgen Lang, Bergisch Gladbach (DE); Gunther Meier, Reinheim (DE); Ralf Müller, Weltersfadt (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/596,320

(22) PCT Filed: Mar. 14, 2008
(86) PCT No.: PCT/EP08/02073

§ 371 Date: Oct. 16, 2009

(30) Foreign Application Priority Data
Apr. 19, 2007 (DE) 10 2007 018 903.8

(51) Int. Cl. G06K 19/06; G06K 7/00

(52) U.S. Cl. 235/435; 235/494

(57) ABSTRACT

There is provided a method for detecting a machine-readable code that has been applied onto a mailpiece in a selected area of a surface of the mailpiece, whereby the selected area is at least 1 cm away from at least one nearby edge area of the mailpiece. An exemplary method comprises checking for the presence of at least two parallel lines in the selected area. The exemplary method also comprises beginning a detection of modules of the machine-readable code comprising a data-matrix code at a predefinable distance from one of the lines.

### CROSS REFERENCE TO RELATED APPLICATIONS

Pursuant to 35 U.S.C. §371, this application is the United States National Stage Application of International Patent Application No. PCT/EP2008/002073, filed on Mar. 14, 2008, the contents of which are incorporated by reference as if set forth in their entirety herein, which claims priority to German (DE) Patent Application No. 10 2007 018 903.8, filed Apr. 19, 2007, the contents of which are incorporated by reference as if set forth in their entirety herein.

### BACKGROUND

It is a known procedure to apply machine-readable codes onto mailpieces. These machine-readable codes can be, for example, data matrix codes. Data matrix codes have the advantage that they allow a high density of information and that the information contained therein can be machine-read quickly and reliably by an appropriate reading device.

For this reason, data matrix codes find widespread use as machine-readable representations of postage indicia.

If graphic images that are similar to the postal matrix code appear in the franking zone, the recognition of the postal matrix code in a reading machine is made more difficult or takes longer. In an extreme case, customers apply their own two-dimensional barcode (e.g. for use by the recipient), and when the reading machine first detects this code, it has to evaluate it in order to recognize that this code is not the data matrix code that contains the postal information.

### SUMMARY OF THE INVENTION

Exemplary embodiments of the present invention relate to a method for detecting a machine-readable code that has been applied onto a mailpiece, to a device for carrying out the method, to the mailpiece and to a method for applying the machine-readable code onto the mailpiece.

In addition, exemplary embodiments of the present invention relate to a method for detecting a machine-readable code that is present on a mailpiece, whereby the information contained in the code can be ascertained especially quickly and reliably.

According to an exemplary embodiment of the present invention, machine-readable code is detected in a selected area of a surface of the mailpiece, whereby the selected area is at least 1 cm away from at least one nearby edge area of the mailpiece.

Thus, an area of a surface of the mailpiece may be selected in which distortions of the code are avoided.

Moreover, an exemplary embodiment of the present invention comprises a systematic selection of an area for the detection (detection area).

In another exemplary embodiment of the present invention, it is checked whether at least two parallel lines are present in the selected area and the detection of modules of the machine-readable code begins at a predefinable distance from one of the lines.

In this manner, the point in time at which modules of the machine-readable code are detected may be reached considerably sooner.

In another exemplary embodiment of the present invention, modules that are one module wide are used, and the modules are detected at a distance from the line amounting to the width of at least one module.

According to an exemplary embodiment of the present invention, the modules may be detected at a distance from the line amounting to the width of two modules.

An exemplary embodiment of the present invention relates to arranging at least two parallel lines adjacent to a data matrix code.

The two parallel lines may allow a quick determination that an appertaining data matrix code contains information that is to be detected.

Two parallel lines can be located especially quickly during a graphic detection of a surface of a mailpiece.

By beginning a detection procedure of the data matrix code in the immediate vicinity of the parallel lines, the presence of a code that is to be detected can be ascertained especially quickly and reliably.

In this manner, a code that is to be detected can be recognized much more quickly and reliably than in the state of the art, thanks to a complete filling of the left-hand and lower edges of the data matrix code.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that the machine-readable code has a data matrix code containing postal information and at least two parallel lines.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that the data matrix code has modules that are one module wide and that the width of at least one of the lines equals the module width.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that at least two of the parallel lines are at a distance from each other that corresponds to the module width.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that a distance amounting to the width of at least one module is present between the data matrix code and a line that is closest to said code.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that a distance amounting to more than the width of one module may be present between the data matrix code and the line that is closest to said code.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that a distance amounting to the width of two modules may be present between the data matrix code and the line that is closest to said code.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that, in addition to the data matrix code containing postal information, additional data matrix codes may be present on the mailpiece.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that the postal information contains shipping information.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that the postal information contains franking information.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that postal information in the form of a data matrix code may be applied onto the mailpiece and that at least two parallel lines may be printed onto the mailpiece in the vicinity of the data matrix code.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that the parallel lines may be applied parallel to an edge surface of the data matrix code that is in the vicinity of said parallel lines.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that the lines may be applied in such a way that they have a length that essentially corresponds to the lengthwise dimension of an edge surface area of the data matrix code that is adjacent to them.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that at least one surface area of the mailpiece may be checked for the presence of at least two parallel lines and that, parallel to at least one of the lines, modules of a data matrix code undergo a detection procedure.

A refinement of the mailpiece, of the method for applying a machine-readable code onto the mailpiece, of the method for reading the machine-readable code that is present on the mailpiece and of the device for processing the mailpiece according to exemplary embodiments of the present invention provides that the device has a detector that is adapted to identify the presence of at least two parallel lines. The device may be equipped in such a way that it starts a detection procedure of modules of the data matrix code at a predefinable distance from the lines.

In the present application, the data matrix code that contains the postal information is also referred to as the postal matrix code.

An exemplary embodiment of the present invention may contain at least one, or perhaps several, of the following features:
special identification of the postal matrix code by an identifier that is easy to find in a reading machine;
an identifier is formed, for example, by at least two vertical lines adjacent to the data matrix code;
the postage indicium contains a postal matrix code that is used for the evaluation by means of a machine;
in addition to the postal matrix code, the franking zone contains additional information/graphics, especially the customer's own graphics.

A module represents the smallest printable width or height (at a given printer resolution). Therefore, the distance between the lines as well as the line width (line thickness) are advantageously the same.

So that a scanner does not recognize the graphics surrounding the data matrix code as belonging to the code, these graphics should be at a distance of two modules from the code. This area is also referred to as the quiet zone. Therefore, it is advantageous to select a distance of at least two modules between the lines and the data matrix code.

The use of lines has the advantage that they are very easy to recognize during a reading procedure. This is especially advantageous when optical character recognition (OCR) is used.

It may be desirable for the lines to have the same height as the data matrix code. In this manner, it may be easier to distinguish the lines from other lines on a mailpiece surface. Moreover, on the basis of the height of the lines or the length of the lines, a reading device can determine the height of the data matrix code that is adjacent to said lines, and thus it can carry out a targeted detection of the modules of the data matrix code. In this manner, the detection procedure of the data matrix code may be made even faster.

Lines are not needed to determine the orientation of the data matrix code or the like; this may be done, for example, on the basis of the left-hand and lower edges of the matrix code, which may be completely filled.

At least one of the data tracks may contain a reference clock.

Exemplary embodiments of the present invention may provide for using a reading unit that generates a graphic image of the machine-readable code.

An exemplary embodiment of the present invention comprises the use of a data processing unit that is configured in such a way that it has a memory in which the graphic image of the machine-readable code is stored.

According to another exemplary embodiment of the present invention, the stored image may be evaluated in such a way that differences between signal intensities are employed in order to determine clock signals of the reference clock.

The term sorting information could refer to information that (1) allows special handling in the mail flow (e.g. prioritized delivery, date-sensitive delivery, special handling of certain contents) and/or that (2) assists with the delivery (e.g. postal codes or other routing encoding, information about the mail control procedures).

The term franking information refers to information that confirms that a mailpiece was franked, e.g. postage value or product designation, referral to a customer number and order number, unambiguous mailpiece identification for mailpiece tracking, etc.

The term postal information encompasses sorting information and/or franking information and, if applicable, information that serves for internal use by the post office for purposes of handling the mailpiece.

Exemplary embodiments of the present invention comprise the use of many types of mail information.

The sorting information is information that can be used to sort the mailpieces.

Fundamentally, various types of sorting information can be employed here.

An exemplary embodiment of the sorting information comprises address information of a recipient of the mailpiece. The address information can be configured in different ways, depending on the intended sorting purpose.

In an exemplary embodiment, the address information can be, for example, a postal code.

Since there is a need to attain the most detailed possible sorting of the mailpieces, it may be advantageous to incorporate additional information into the address information and thus to use it as sorting information.

In particular, street names, street sections and/or house numbers or house number ranges can be used as sorting information.

The sorting information can contain other information in addition to or instead of the above-mentioned types of information.

This information can also include identifiers, especially an identification number.

An exemplary embodiment of the present invention may entail several advantages.

In particular, the code employed may be small and secure.

Moreover, the code can be applied reliably and quickly. Furthermore, it can likewise be read reliably and quickly.

Through the use of a reference clock, the code can be configured to be error-correcting.

In particular, the following errors can be corrected in this manner:

a. deletions (wrinkles, blurred signals),
b. stochastic errors (dirt),
c. systematic errors (absence of a dot, periodical).

An embodiment of the method, of the device and of the mailpiece according to exemplary embodiments of the present invention may provide that additional information is incorporated into the code, and this information allows the correction of errors.

In an exemplary embodiment of the present invention, a Reed-Solomon error correction method may be deployed.

In an exemplary embodiment of the present invention, computer-readable code can be used as a further refinement of prior-art codes as well as in the new development of codes.

As set forth below, one or more exemplary embodiments of the present invention may be used for processing mailpieces in mail centers or freight centers. As a rule, more than 10,000 mailpieces are sorted here within one hour.

### BRIEF DESCRIPTION OF THE DRAWINGS

The figures show the following:

FIG. 1 is a block diagram of a mailpiece according to an exemplary embodiment of the present invention (window envelope, DIN oblong, with franking elements in the franking zone);

FIG. 2 is a block diagram showing an arrangement of the data matrix code according to an exemplary embodiment of the present invention on a mailpiece (structured set-up of the franking elements in the franking zone);

FIG. 3 is a block diagram showing examples of the representation of a logo that can be applied in the vicinity of the data matrix code (surface area of the franking element “logo”) according to an exemplary embodiment of the present invention;

FIG. 4 is a diagram showing a graphic design of the data matrix code with two parallel lines (layout postal matrix code) according to an exemplary embodiment of the present invention;

FIG. 5 is a diagram showing an area of the surface of a mailpiece with a graphic motif and a data matrix code according to an exemplary embodiment of the present invention;

FIG. 6 is a diagram showing an area of the surface of a mailpiece with a plain text depiction of extra services according to an exemplary embodiment of the present invention;

FIG. 7 is a diagram showing an area of the surface of a mailpiece in an especially compact form according to an exemplary embodiment of the present invention;

FIG. 8 is a block diagram showing an arrangement of the data matrix code in a reading area of the mailpiece (structured set-up of the franking elements above the address in the shifting area of the window) according to an exemplary embodiment of the present invention;

FIG. 9 is a diagram showing a graphic arrangement of the data matrix code in an address field (marking in the address zone with the data matrix code 26×26) according to an exemplary embodiment of the present invention; and

FIG. 10 is a diagram showing a graphic arrangement of the data matrix code in an address field (marking in the address zone with the data matrix code 22×22) according to an exemplary embodiment of the present invention.

### DETAILED DESCRIPTION OF SPECIFIC EMBODIMENTS

The figures depict the use of the invention for purposes of marking mailpieces with a machine-readable code and for subsequently reading the machine-readable code, while acquiring sorting-relevant and/or billing-relevant information, with reference to the example of a mail sorting system.

Exemplary embodiments of the present invention may be used for bulk designation of mailpieces as well as for the likewise bulk sorting of mailpieces in a mail center or parcel center.

However, it is likewise possible to carry out at least one of the processing steps in a smaller system.

For example, it is possible to generate the code using a franking machine.

It is also possible to generate the code using a printer, whereby the printer is connected to a computer system.

An exemplary embodiment of the present invention may print the code and additional information—especially a recipient in plain text—in a single processing operation.

By the same token, it may be possible to process the mailpieces in a device intended for smaller mail volumes, for example, for internal mail distribution within a company.

An exemplary embodiment of the present invention may be used for codes that are configured as a two-dimensional data matrix code (2D-code).

The use of a two-dimensional data matrix code (2D-code) means that the information density per unit of surface area can be greatly increased in comparison to one-dimensional barcodes.

The data matrix code exists in various code schemes or “symbologies” (“ECC n”, n=0 to 200; ECC=Error Checking and Correction Algorithm). The most reliably readable code scheme is the ECC 200 scheme. The size of the square code field or, in the case of certain side dimensions, the merely rectangular code field, is determined on the basis of a large selection range; the symbol elements are square or round. This data matrix code is described in ISO (International Organization for Standardization, Geneva, Switzerland), standardized in ISO/IEC 16022:2000 and ISO/IEC 24720:2006 as well as in other standards for applications such as, for example, DIN standards and DIN-EN standards. These standards are binding throughout the industry.

In the data matrix code, the information may be encoded very compactly as a pattern of dots in a square or rectangular surface area. An exemplary data matrix code contains redundant data so that up to 25% of the errors in the individual elements can be automatically corrected, for instance, by using a Reed-Solomon error correction (ECC 200) (if, for example, parts of the code were covered up or destroyed).

When a data matrix code is read, an arrangement of dots may be determined within a border (finder pattern) and in the grid of the matrix. The dots may be black or white cells that are adjacent to each other or else round dots with gaps between them. In this manner, the recognition of the information becomes much more reliable and the dimension of the code becomes much more compact.

In an exemplary embodiment of the present invention, a data matrix code may comprise four or five main components:

### 1. The Two Pairs of Fixed Solid or Broken Edges as Delineation Lines (‘Finder Pattern’)

The fixed delineation lines serve for delineation purposes. This delineation is used for aligning and equalizing the data matrix code so that any reading angle is possible. In the case of larger codes, so-called alignment bars (alignment patterns) are also used.

2. The Corner Opposite from the Continuous Edges

This corner allows the rapid recognition of the code scheme. In the case of the ECC 200 code scheme with an even number of lines and columns, the element in the upper right-hand corner is always white. In the other standardized code schemes with an odd number of lines and columns, the element in the upper right-hand corner is always black.

### 3. The Data Range

This data range contains the actual binary information in encoded form. Therefore, depending on the size of the matrix, the possible number of pieces of information is also defined.

### 4. The ‘Quiet Zone’

This quiet zone surrounds the data matrix code. It does not contain any information or patterns. The width of the quiet zone is at least one column or one line, and it is needed for delineation purposes from other optical image elements nearby.

### 5. The ‘Auxiliary Lines’

This paired combination of solid and broken lines in the horizontal direction as well as in the vertical direction (alignment pattern) facilitates the image evaluation. These lines divide large data fields into equal-sized parts. Each partial field can be evaluated as a single data matrix code.

Using the 144×144 ECC 200 data matrix code (in addition to the finder pattern and the alignment pattern), up to 1558 bytes (with 8 bits/byte) can be encoded, thus, 3116 digits (3.5 bits) or 2335 ASCII characters and special characters with an expanded character set (7 bits).

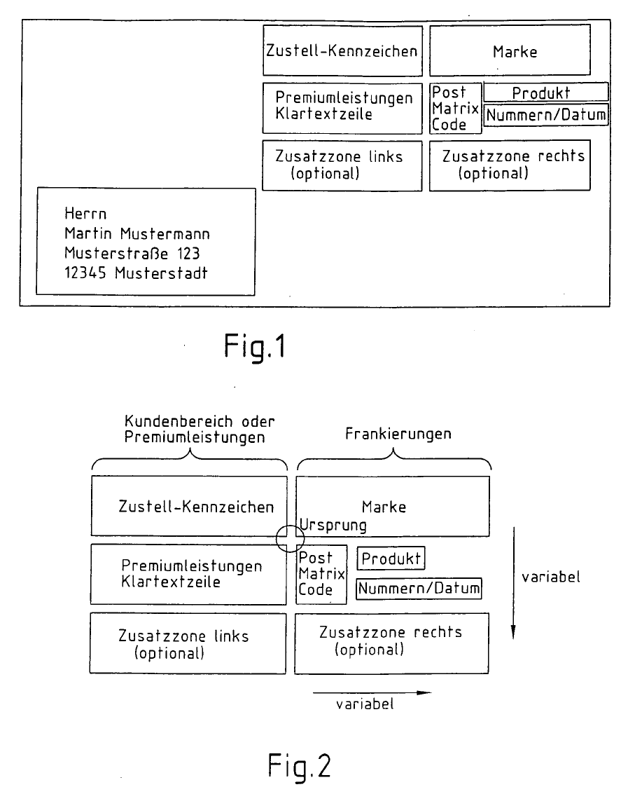

FIG. 1 shows a mailpiece according to an exemplary embodiment of the present invention.

This is a schematic depiction in which the data matrix code, referred to as a postal matrix code, is depicted as a black surface.

Additional graphic information is located between the data matrix code according to an exemplary embodiment of the present invention and the edge areas of the mailpiece. In this manner, it is possible to combine a comprehensive utilization of the printable areas with the advantage that the data matrix code according to an exemplary embodiment of the present invention has a predefinable minimum distance from the edge surfaces of the mailpiece, preferably in the order of magnitude from 0.5 cm to 5 cm. This improves the recognition of the data matrix code. This is especially advantageous with those mailpieces that are curved in the edge areas, which can occur, for example, with mailpieces that are completely stuffed.

The data matrix codes may be used for a machine-readable representation of franking information. Here, current as well as future franking methods can be used. Examples of exemplary embodiments of digital franking methods are the following digital franking methods offered by Deutsche Post AG:
digital stamp
eStamp
franking service
FRANKIT
computer franking
Infopost with premium address.

### Structure

In an exemplary embodiment of the present invention, the marking in the franking zone may comprise eight franking elements that are shown in color in the next two figures.

In FIG. 2, an exemplary embodiment of the franking elements are shown in enlarged form.

FIG. 2 shows a section of the surface of the mailpiece depicted in FIG. 1.

The section depicted in FIG. 2 shows an arrangement of the data matrix code in a printing area.

The exemplary printing area shown in FIG. 2 is divided into several sections. A left-hand section makes it possible to place information about extra services. This section contains, for example, a delivery identifier, an indication of available premium services in plain text—for example, by an abbreviation that represents these services.

Thus, for example, it is possible to identify a registered letter with the abbreviation R. Additional information can be applied in an additional zone of the customer area or of the premium service area.

In the exemplary embodiment shown in FIG. 2, a franking area is located to the right, adjacent to the customer area or premium service area.

At its upper end, the franking area has a graphic depiction, for example, a logo of the logistics company that transports the mailpiece. The placement of the logo in this area entails several advantages. First of all, this makes the logo especially easy for a sender or recipient of the mailpiece to recognize. Furthermore, the placement of the logo in this area establishes a minimum distance between the upper edge of the mailpiece and the data matrix code.

The data matrix code according to the invention is located below the logo. This code is referred to in the figure as the postal matrix code because it contains postal information, especially franking information.

To the left, adjacent to the data matrix code, there are two parallel lines of the same height as the data matrix code. The two parallel lines are preferably arranged parallel to the orientation of the franking area and thus make it even easier to locate the data matrix codes that are to the right, adjacent to them.

In an exemplary embodiment of the present invention, an outer line of the parallel lines runs in such a way that it is located in an extension of a printing area of other constituents of the franking area, especially of the printing area for the logo. This makes it easier to locate the line and thus to locate the data matrix code that is arranged adjacent to it.

The set-up of the data matrix code and of the parallel lines arranged to the left, adjacent to it, is shown in greater detail in FIG. 4.

FIG. 2 shows an arrangement of the data matrix code according to an exemplary embodiment of the present invention on a mailpiece, making reference to a structured set-up of the franking elements in the franking zone.

The contents of the eight franking elements will be described in the following paragraphs.

The printing area intended for a logo, especially the logo of a logistics company that transports the mailpiece—below called the logo area—has a surface area of several mm². In the case shown here by way of an example, this is a surface area measuring 35 mm×7 mm in size.

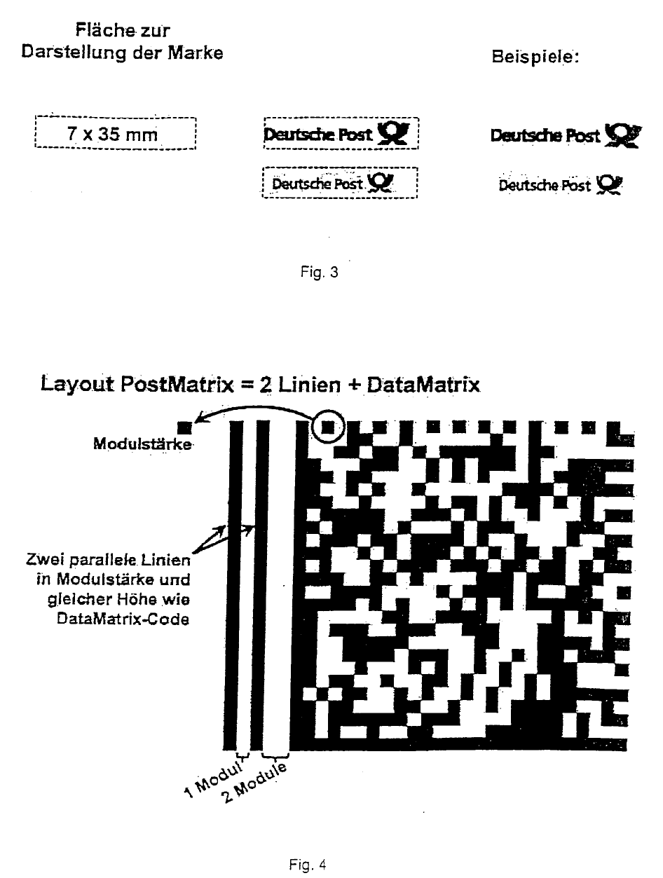

FIG. 3 shows examples for printing the logo area with a logo of a logistics company and thus it illustrates the surface area of the franking element “logo”.

In the exemplary embodiment of the logo area shown in FIG. 1, the surface area for depicting the logo is, for example, 7 mm×35 mm
the logo of the logistics company, for example, with black font on a white background.
In this variant, the left-hand edge of the capital letter “D” of “Deutsche Post” constitutes the left-hand edge of the logo. In comparison to the variant below, the lettering “Deutsche Post” and the post horn are thus on a larger scale.
the logo of the logistics company with black font on a yellow background. In this variant, the left-hand edge of the yellow frame is the left-hand edge of the logo. In comparison to the variant described above, the lettering “Deutsche Post” and the post horn are thus on a smaller scale.

It should be possible to choose between either logo for all franking modalities.

The integration of other logos is possible if so desired.

An exemplary embodiment of a postal matrix code is shown in FIG. 4. This exemplary embodiment shows a two-dimensional barcode—data matrix code—and two lines.

The exemplary data matrix code contains the information needed for a given franking modality in digital, machine-readable form.

The module size can vary between an upper and a lower value. Although large variation ranges are possible, small variation ranges are preferred for the module size since this means that the modules will be recognized more easily and reliably. In particular, it is advantageous for the variation of the module size to be considerably less than the module size itself so as to avoid inadvertently reading a large module as two small modules. In prior-art processing units for mailpieces, a variation of the module size from 0.4 mm to 0.6 mm is especially preferred.

However, it is likewise possible to select a smaller variation range, for example, between 0.4233 mm and 0.508 mm The resolution of the printer employed has to be taken into consideration when the module size is specified. A module always has to be a whole multiple of physical printing dots of a printer. At a customary print resolution of 300 dpi (dots per inch; 1 inch=25.4 mm), a single printing dot is 0.084666 mm in size. Five of these printing dots add up to a width of 0.4233 mm Six of these printing dots add up to a width of 0.508 mm.

Therefore, in order to ensure a high degree of edge sharpness, either the module size of 0.4233 mm or the module size of 0.508 mm has to be used at this resolution. Each value in-between would cause a “ragged edge” in the printed image, which can lead to errors in the recognition process.

The upper left-hand corner of the data matrix code contains the origin of the postage indicium. If the sizes are variable, the data matrix code may be anchored at this corner and thus becomes larger to the right and downwards. The franking elements located further to the right and further down retain their relative distance to the edge of the data matrix code and consequently, they change their absolute position in the postage indicium.

### Product Designation

Product designations may be placed to the right, adjacent to the data matrix code. The area for placing the product designation comprises two lines. As a rule, only the first line is needed. For certain products, both lines are necessary. At times, different names may be also used in the images in order to illustrate the effect of new product names.

### Number and Date Lines

In an exemplary embodiment of the present invention, information is provided in the area of the two number and date lines—as a function of the franking modality and the use of extra services—about the customer, about the order on hand, about the franking system employed, about the identification of the individual mailpiece and/or about the security pertaining to the predictability of Identcodes. Moreover, the postal code and the date may be printed likewise as a function of the franking modality.

Elements that are shown in angle brackets may be used to describe the contents of the number and date lines.

According to an exemplary embodiment of the present invention, following elements are employed:

<serial number>

<customer number>

<transaction mailpiece>

<order>

<date>

<month>

<validity>

The elements may be arranged in such a way that fixed information is in the first line and variable information is in the second line.

Set-up of the number and date lines for FRANKIT:

<serial number>
<transaction mailpiece>
<date>

Set-up of the number and date lines for the digital stamp:

<serial number>
<transaction mailpiece>
<validity>

Set-up of the number and date lines for the eStamp:

<serial number>
<transaction mailpiece>
<validity>

Set-up of the number and date lines for the computer franking (complete) (recommended for all mailed letters; required for BZL and services based on the mailpiece ID):

<customer number>
<order trans mailpiece><date>

Set-up of the number and date lines for the computer franking (abbreviated) (sufficient for Infobrief/Infopost, only possible for letters if no extra services are to be used):

<customer number>
<order><month>

Set-up of the number and date lines for Infopost premium address (complete) (recommended version):

<customer number>
<order trans mailpiece><date>

Set-up of the number and date lines for Infopost premium address (abbreviated)<customer number><order><month>

Set-up of the number and date lines for the franking service:

<customer number>
<order trans mailpiece><date>

Set-up of the number and date lines for Infopost with order number:

<customer number>
<order><month>

### Delivery Identifier

In the franking element “delivery identifier”, the delivery identifiers for registered letters, COD deliveries and premium address services may be indicated in the form of capital letters.

### Premium Services Plain Text Line

In the franking element “premium services plain text line”, the applicable premium services may be indicated. In the case of combinations of premium services, the order of the texts corresponds to the order of the delivery identifiers.

### Additional Zones

In the franking element “additional zones”, divided into left and right, additional form-free and content-free information can be depicted for certain franking modalities.

Application examples are hotline numbers, Internet addresses or event-specific texts.

It is possible to use additional zones for the digital stamp, computer franking, and eStamp. In the case of FRANKIT, the printing technology determines the conditions of use.

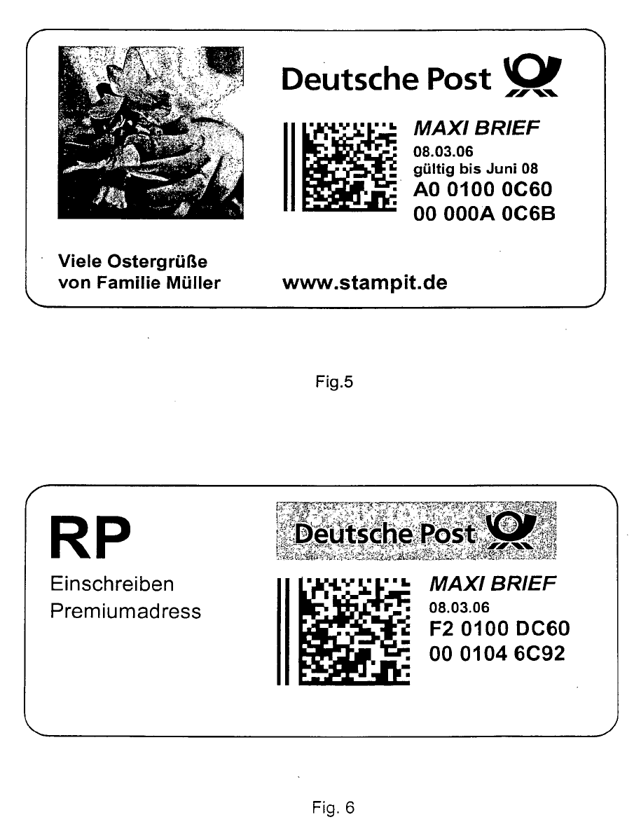

FIG. 5 shows an exemplary arrangement of the data matrix code according to the invention in the surface area of a mailpiece.

The data matrix code as well as the parallel lines arranged adjacent to it have the structure explained above, making reference to the exemplary embodiment shown in FIG. 4.

The logo area explained with reference to FIG. 3 is located above the data matrix code.

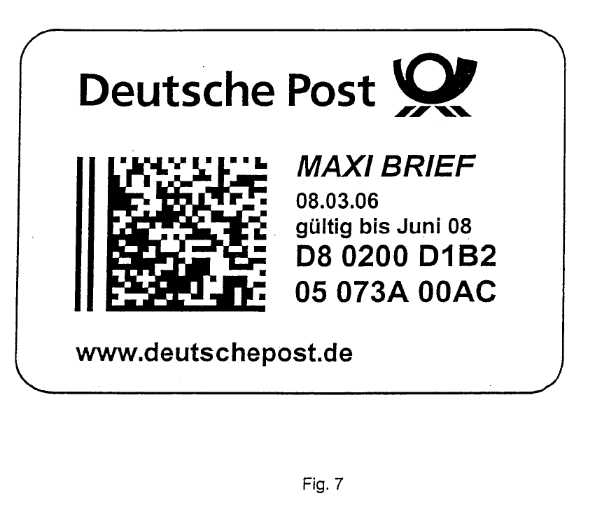

To the right, adjacent to the data matrix code, there is an area for printing product, number and date information. This information is printed, for example, in plain text, as is shown below with reference to FIGS. 6 and 7.

A freely printable area is located to the left, adjacent to the data matrix code and/or left adjacent to the logo area.

Examples of the digital stamp are presented below (FIGS. 6 and 7).

FIG. 6: digital stamp with extra services

FIG. 7: digital stamp in an especially compact form

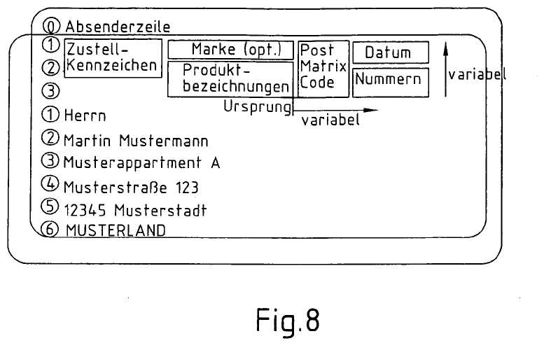

The franking elements are depicted in enlarged form in FIG. 8. Two window contours, which are offset with respect to each other, depict a case where the letter has shifted in the envelope.

This example elucidates another advantage of the above-described arrangement of the data matrix code. By inserting an area above the data matrix code, it is possible to determine the content of the data matrix code, even if the letter in the window envelope has shifted.

FIG. 8: structured set-up of the franking elements above the address in the shifting area of the window

The contents of the seven franking elements are described in the paragraphs below.

### Logo (Optional)

In the logo area, the lettering “Deutsche Post” with a post horn is shown for use in Germany, in accordance with the Corporate Design. The integration of other logos is possible if so desired.

In the start-up phase, only one variant with black font on a white background is used, whose dimensions are fixed.

This franking element can be eliminated if the logo of the logistics company is printed on the envelope within the scope of a reference to the franking in the window and if no extra services are being used. In this case, the franking element “logo” remains empty.

### Postal Matrix

The franking element “postal matrix”, like the postage indicium in the franking zone, may comprise a two-dimensional barcode of the code type data matrix code and two lines. The data matrix code may contain the information needed for the particular franking modality in digital, machine-readable form.

The module size can theoretically vary between 0.4233 mm and 0.508 mm The resolution of the printer employed has to be taken into consideration when the module size is determined. A module includes a whole multiple of physical printing dots of a printer. At a customary print resolution of 300 dpi (dots per inch; 1 inch=25.4 mm), a single printing dot is 0.084666 mm in size. Five of these printing dots add up to a width of 0.4233 mm. Six of these printing dots add up to a width of 0.508 mm. Therefore, in order to ensure a high degree of edge sharpness, either the module size of 0.4233 mm or the module size of 0.508 mm has to be used at this resolution. Each value in-between would cause a “ragged edge” in the printed image, which can lead to errors in the recognition process.

With computer franking, the module size may be selected, taking the available printer resolution into consideration.

The lower left-hand corner of the data matrix code contains the origin of the postage indicium. If the size is variable, the data matrix code is anchored at this corner and thus becomes larger to the right and upwards. The franking elements located further to the right and further upwards retain their relative distance to the edge of the data matrix code and consequently, they change their absolute position in the postage indicium.

The lower edge of the data matrix code is at a distance of 1 mm from the line of text located under it (first address line).

### Product Designation

Product designations may be placed to the left, adjacent to the data matrix code, below the logo/post horn. The area for placing the product designation comprises two lines. As a rule, only the first line is needed. For certain products, both lines may be necessary.

In order to avoid an impairment in the reading of the address, product designations need not contain any digits when they are franked in the address zone. A difference franking like with the digital stamp may be less advantageous in this context.

### Date and Numbers

Information may be provided in the area of the date and of the numbers—depending on the franking modality and the use of extra services—about the customer, about the order on hand, about the franking system employed, about the identification of the individual mailpiece and/or about the security pertaining to the predictability of Identcodes. Moreover, the postal code and the date may likewise be printed, as a function of the franking modality.

In order to describe the contents of this area, elements may be used that are shown in angle brackets. The following elements may be used:

<serial number>

<customer number>

<transaction mailpiece>

<order trans mailpiece>

<order>

<date>

<month>

Set-Up of Date and Numbers for the Computer Franking (Complete)

The following three items of information may be used if premium services are desired that are based on mailpiece identification (e.g. registered letter). Otherwise they may be deleted without substitution:

<date>

<customer number>

<order trans mailpiece>

Set-Up of Date and Numbers for the Computer Franking (Abbreviated)

As an alternative to the above-mentioned information (complete), the abbreviated information is possible if premium services are desired that can also be used without mailpiece identification (e.g. premium address). Otherwise they may be deleted without substitution:

<month>

<customer number>

<order>

Set-up of date and numbers for the computer franking:

<date>

<serial number>

Set-up of dates and numbers for Infopost premium address (complete) (recommended version):

<date>

<customer number>

<order trans mailpiece>

Set-up of date and numbers for Infopost premium address (abbreviated)

<month>

<customer number>

<order>

### Delivery Identifier

In the franking element “delivery identifier”, the delivery identifiers may be indicated in the form of capital letters for registered letters, COD deliveries and premium address services.

### Premium Services Plain Text Line

Premium services in plain text are not indicated in the postage indicium. Therefore, in the entire process, the extra services have to be printed out in plain text during the scanning procedure before the delivery (scanning and printing station SPS).

### Dimensioning and Examples

Markings in the address zone may be structured and dimensioned as follows as a function of the data matrix code employed:

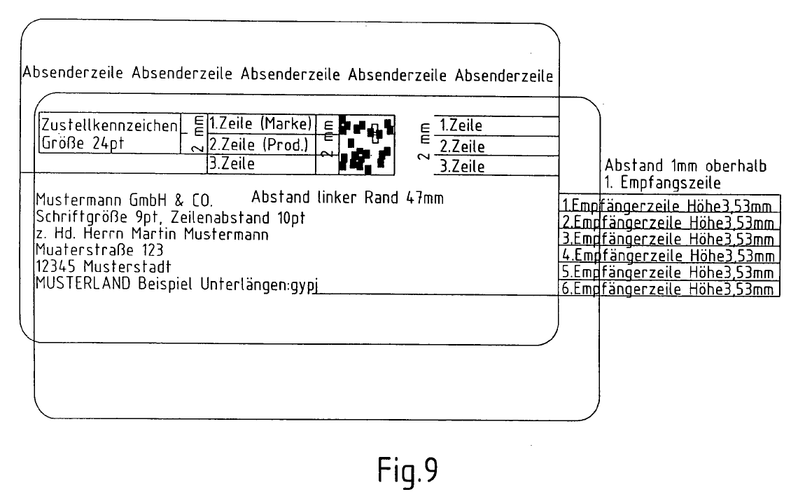

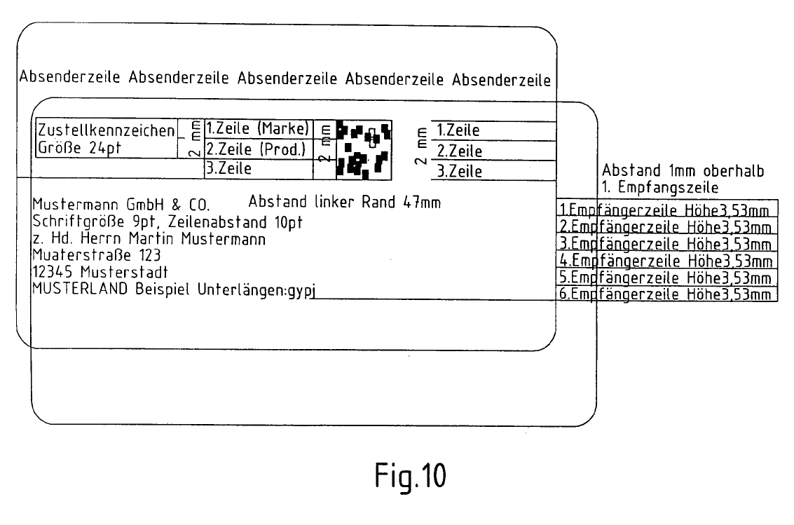

FIG. 9: marking in the address zone with the data matrix code 26×26 and
FIG. 10: marking in the address zone with the data matrix code 22×22

FIGS. 8, 9 and 10 and FIG. 9 schematically show a postage indicium according to the invention applied onto a mailpiece. As can be seen in this embodiment, the data matrix code is still readable, even if the letter arranged in a window envelope has slipped away from its proper position. In this manner, the depicted postage indicium—in the case shown here, computer franking—is still readable in a processing unit or by a reading unit.

Exemplary embodiments of the present invention can also be used in the case of the integration of symbols.

Below, the term “symbol” is shown to represent an element from the set of all representable characters with the selected symbology.

The set of representable characters is also referred to as the alphabet. Each symbol in a binary representation requires a fixed number of bits; this is determined by the number of possible symbols in the alphabet.

An encoding procedure according to an exemplary embodiment of the present invention using symbols with 6 bits is shown below.

These symbols may then form the basis for the error correction. In other words, it is not individual bits that are corrected but rather always entire symbols with 6 bits. Thus, the alphabet here comprises 64 symbols.

The term “track” refers to a reading line in a code that consists of several lines arranged one above the other. Like with an audio tape, the code passes the fixed reading head so that the scanning takes place one line at a time.

Fundamentally, it is also possible for a movable reading head to be moved relative to the code in the lengthwise direction of the code.

Owing to the evaluation of the images of the machine-readable code taken previously according to the invention, it is also possible to detect the code in a single work step. This can be done, for example, by using an imaging device that is otherwise used in other technical areas, for example, in digital photography or in digital copying.

When the code is being selected, care should be taken to ensure that it fits as well as possible with the expected error structure. The various error situations are, for example:

poor print

substrate that prevents the reading

subsequent change (dirt, writing)

covered up areas/deletions, e.g. due to wrinkles

etc.

According to an exemplary embodiment of the present invention, it is possible to achieve a complete error correction of the code according to the invention.

The decisive aspect is the amount of useful information within the code.

A Reed-Solomon error correction may be used on symbols having, for example, 6 bits. Here, start/stop characters or synchronization characters are included in the computation, since they likewise increase the reading accuracy by adding redundancy. On average, a code rate of preferably at least 20% is used. It is even more advantageous to employ a code rate of at least 30%, whereby further improvements are achieved with a code rate of at least 40%. The exemplary embodiments shown relate to an especially preferred code rate of approximately 46%.

An exemplary code contains useful information, 42 bit/98 bit code=42.9%; this includes 2×2 bits start/stop.

With this setting, the correction possibilities are quantified as follows:

Maximum correction of erroneous symbols 4 (3)
Maximum correction of deleted bars 8 (7)
Correction of bundle errors bars 10 (7)
Correction of bundle deletions bars 22 (19)

The values for 7 error correction symbols are shown in parentheses.

Especially in the correction of bundle errors and bundle deletions (both burst errors), 3 more bars are corrected. Burst errors, i.e. erroneous or overlapping bars are to be expected, for example, in case of wrinkles.

It is possible to use an error correction corresponding to the UPU specification with the preferred adaptations presented below.

This is done, for instance, with the error correction method presented below:

Error correction method: Reed Solomon

Galoir field: GF(64)=GF (2⁶)
Primitive polynomial: p(x)=x⁶+x+1
Generator polynomial: g(x)=λ⁸ᵢ₌₁(x+aⁱ)
Generator element: a=000010=2
The code structuring is carried out systematically analogously to UPU.

However, it is likewise possible to employ alternative error correction methods.

Such alternative error correction methods will be explained below.

Two important code types are the block code and the convolutional code. In the section above, the requirements for purposes of error correction were selected according to a block code.

In the block code, the input data is divided into blocks having the length m (m=number of symbols) and k redundancy bits are added after each block; hence, the new block length is n=m+k bits. The code rate R is defined as the ratio of the information bits m to the total block length n. Block codes are thus suitable for the correction of symbol errors.

In contrast, the convolutional code “spreads” the input data over several output bits. For this purpose, the input data is read into a shift register and the output data is generated by combining several access operations carried out at the register. The code rate R is defined here as the quotient of the m bits that are read in at once over the n bits that are read out at once. Thanks to this type of encoding, convolutional codes are suitable for correcting individual bit errors.

Convolutional codes are binary codes in which the input bits are “spread” over several output bits. During the final encoding, the input data is read into the shift register and the output data is determined by combinations of access operations (for the most part, these are EXOR operations).

The length S of the shift register yields a storage depth of S times m=3. The influencing length, in contrast, is K=(S+1) times m=4. The arrangements of the access operations in the encoders are often indicated by generator polynomials or as an octane number.

In an exemplary embodiment of the present invention, one way to increase the efficiency of codes is to link several codes to each other. The first code is called the outer code, and the second code is called the inner code.

If, for example, a block code is selected as the outer code and a convolutional code is selected as the inner code, then the inner code can correct individual bit errors and the outer code can correct smaller burst errors. In order to be able to correct larger burst errors as well, an interleaver is placed between the two encoders.

It is advantageous to select the encoding in a given application case as a function of the errors that are to be expected.

Accordingly, the Reed-Solomon encoding described here is only to be understood by way of an example and, in any individual case, can be replaced with another error correction method.

The exemplary embodiments presented here show an arrangement of two parallel lines adjacent to the data matrix code. This presented embodiment is especially advantageous for the reasons explained with reference to the figures.

However, exemplary embodiments of the present invention also encompass embodiments with another number of lines. In particular, it is possible to use three or more lines instead of the two lines discussed here. However, the person skilled in the art will realize that, with two parallel lines, he can already achieve the above-described advantages of easier recognition.

1-17. (canceled)

18. A method for detecting a machine-readable code that has been applied onto a mailpiece in a selected area of a surface of the mailpiece, whereby the selected area is at least 1 cm away from at least one nearby edge area of the mailpiece, the method comprising:
checking for the presence of at least two parallel lines in the selected area; and
beginning a detection of modules of the machine-readable code comprising a data-matrix code at a predefinable distance from one of the lines.

19. The method according to claim 18, comprising detecting the modules at a distance from the line amounting to the width of at least one module, when modules that are one module wide are used.

20. The method according to claim 19, comprising detecting the modules at a distance from the line amounting to the width of two modules.

21. A device for processing a mailpiece, the device comprising a detector that is adapted to identify a machine-readable code comprising a data-matrix code that has been applied onto the mailpiece, the detector being adapted to detect the presence of at least two parallel lines, the detector being adapted to start a detection procedure of modules of the data matrix code at a predefinable distance from the lines.

22. A mailpiece with a machine-readable code disposed thereon, the machine-readable code having a data-matrix code containing postal information and at least two parallel lines that are adjacent to the data-matrix code.

23. The mailpiece according to claim 22, wherein the data-matrix code has modules that are one module wide and wherein the width of at least one of the lines equals the module width.

24. The mailpiece according to claim 22, wherein at least two of the parallel lines are at a distance from each other that corresponds to the module width.

25. The mailpiece according to claim 22, wherein a distance amounting to the width of at least one module is present between the data matrix code and a line that is closest to the code.

26. The mailpiece according to claim 22, wherein a distance amounting to more than the width of one module is present between the data matrix code and the line that is closest to the code.

27. The mailpiece according to claim 22, wherein a distance amounting to the width of two modules is present between the data matrix code and the line that is closest to the code.

28. The mailpiece according to claim 22, wherein additional data matrix codes are present on the mailpiece.

29. The mailpiece according to claim 22, wherein the postal information contains shipping information and/or franking information.

30. A method for applying a machine-readable code onto a mailpiece, the method comprising:
applying postal information in the form of a data matrix code onto the mailpiece; and
printing at least two parallel lines onto the mailpiece in the vicinity of the data matrix code, the lines being adjacent to the data-matrix code.

31. The method according to claim 30, comprising applying the parallel lines parallel to an edge surface of the data matrix code that is in the vicinity of the parallel lines.

32. The method according claim 30, comprising applying the lines so that they have a length that essentially corresponds to a lengthwise dimension of an edge surface area of the data matrix code that is adjacent to them.
